(19) United States
(12) Patent Application Publication
(10) Pub. No.: US 2006/0217110 A1
(43) Pub. Date: Sep. 28, 2006

(54) Prioritizing the display of non-intrusive content on a mobile communication device

(75) Inventor: Konstantin Othmer, Mountain View, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Core Mobility, Inc., Mountain View, CA (US)

(21) Appl. No.: 11/090,724

(22) Filed: Mar. 25, 2005

(51) Int. Cl. H04Q 7/38

(52) U.S. Cl. 455/414.1

(57) ABSTRACT

Advertisements and the timing of the display thereof on tickers of mobile devices are selected based on activity of the mobile devices and bids made by advertisers. Advertisers define conditions of the mobile devices that are to trigger the display of particular advertisements. The advertisers can also bid for priority placement of advertisements and can set spending limits to manage budgets. During use of a mobile device in a mobile communications network, parameter data defining conditions associated with the mobile device and the operation thereof is generated. The mobile device also generates event data defining events or activity of the mobile device or the associated mobile user. The parameter data and the event data are used by an advertising system of the mobile communications network to select an advertisement and the timing of the display of the advertisement, respectively. Any priority given to particular advertisements based on bids made by advertisers is also used to select the advertisement.

### BACKGROUND OF THE INVENTION

1. Field of the Invention

This invention relates to the purchase and sale of advertising space on wireless devices. More specifically, the invention is directed to systems and methods for permitting wireless marketers to purchase priority advertising space on wireless devices for the purpose of presenting non-intrusive content to a mobile audience.

2. Related Technology

Driven by phenomenal technological advances and dynamic social change, the multi-billion dollar wireless industry is in a state of exuberant innovation and aggressive expansion. The ubiquity and variety of mobile devices and the establishment of wireless network infrastructures have changed the way that companies, government entities and individuals interact, conduct business, manage affairs and exchange all manner of verbal, visual and written communications.

In addition to the widespread acceptance of basic digital mobile phones, smart phones offering multiple flavors of messaging (SMS, MMS, IM), email, Internet browsers, digital cameras, games, wireless Bluetooth connectivity and personal applications such as calendars, “to do” lists and notepads, are exceedingly popular among early adopters of the technology. The vigorous growth of these and other mobile technologies continues to be driven by several factors: (1) optimizations in many areas, including chip speed, hard disk and battery size and capacity, compression, bandwidth, and service coverage and security; (2) the international deployment of wireless voice and data networks, such as WiFi and the entire family of 802.11 local area networks, the Internet and Bluetooth personal area networks (Bluetooth is a short-range radio frequency technology that provides wireless data connections between devices in close proximity); (3) the convergence of the mobile phone with other wireless devices, including PDAs, digital cameras, gaming devices and media players (MP3, “video” or radio), and; (4) the U.S. Wireless Communication and Public Safety Act of 1999 (a.k.a. e911).

The e911 legislation mandates that handset manufacturers must install “homing chips” in all wireless phones that will operate in the United States. Homing chips transmit location information about a mobile phone to its network operators and, in the event of an emergency, the network operators are then able to provide the precise geographic location of any mobile phone to emergency services. A by-product of this legislation is that it is now possible for handsets to “know” where they are, and therefore possible for network operators to intelligently control and populate them with customized location-based content from multiple sources.

This confluence of circumstances and events—rapid adoption of new wireless technologies, improved resiliency of service, increased data transmission rates, the e911 law requiring homing chips, and market precedents which show that mobile device users are willing to pay for wireless services or applications—establish the feature-rich wireless station as an increasingly logical and compelling channel for the free flow of communications, information, entertainment and commerce.

Propelled by these developments, companies are beginning to develop mobile applications and services. A mobile application or service adds additional functionality to a wireless device. Examples include a service that automatically synchronizes contact lists on a laptop and handset, or an application that connects a mobile device to a gasoline pump or vending machine, in order to process a purchase that is automatically charged to the user's phone bill. Mobile solutions for the enterprise include customer relationship management and sales force automation tools. Existing service providers, such as companies that specialize in geographic mapping and modeling systems, have forged ahead to explore and commercialize their resources and expertise by developing ways to integrate information tracking, alerts and navigation aids for deployment in other wireless applications. Media and media distribution companies that have successfully streamed content on the Internet by broadcasting headlines via RSS (Really Simple Syndication) are poised to employ wireless news aggregators to convey customized information to mobile users. Based on user preferences and applicable carrier or government regulations, this content may include news, entertainment, stock quotes, weather, directions, personal emails, emergency alerts, advertising and other information, and can be transmitted and presented on the device via various mechanisms.

Tickers used in mobile devices represent one example of a mechanism for transmitting and presenting customized information to mobile users. Such tickers can be instantiated in various ways and their content presented in multiple formats, such as streaming text, graphics, audio or “video.” Non-intrusive advertising messages can be passively presented to the user of the device using any format available to the ticker. Additional details regarding tickers displayed on mobile devices are included in U.S. patent application Ser. No. 10/916,960, filed Aug. 11, 2004, which is incorporated herein by reference.

The growth of electronic communication in recent years has led to an increase in the amount and variety of marketing and advertising carried over telecommunication systems, such as wireless networks. In some ways, mobile marketing on wireless devices is similar to traditional advertising venues such as television, radio, magazines, newspapers, billboards and shopping carts, to name a few. Paradigms already exist for purchasing traditional print and broadcast ads, as well as the new media of the Internet. Traditional media sales for print, radio and television are governed by large agencies or brokers. With a goal of reaching a particular audience, the advertiser evaluates the demographics of various mediums and, depending on the campaign budget, purchases ad space by calling the appropriate account representative or agency, negotiating a price and agreeing to provide ad materials in the correct format by a certain date. Purchasing ad space in traditional media—especially preferential spots like the front inside cover of Time magazine or a 30-second slot during the Super Bowl halftime show—requires long lead times and deep pockets. Usually, there is no way to exactly determine how many people in the target audience actually heard or saw the ad, and so it is extremely difficult for advertisers to accurately measure the number of impressions of one particular campaign, let alone evaluate the effectiveness of one appearance of the ad.

On the Internet, in addition to an advertiser's own Web site, media space is available in the form of site banners, search page listings, “pop-ups” and “pop-unders.” (The latter two types of ads have multiple flavors and names—slash pages, interstitials, superstitials, metastitials—but simply, they are all intrusive ads that are sent to a person viewing a Web site without specifically being requested). Internet advertising can be purchased following the traditional methods described above or via online auctions; in both cases, the purchaser selects a URL, or a keyword that “triggers” the ad to be displayed in the window.

Like traditional television advertising, Internet advertisers can purchase advertising space based on the number of impressions received by the ad. An impression is a single display of a creative work. Even for the Internet, however, this method for determining ad cost is somewhat faulty, since it is actually impossible to definitively conclude whether any particular banner ad is either delivered to or viewed by someone in the identified target audience. Therefore, correlating impressions with a successful campaign is inaccurate and the advertiser may ultimately pay for exposure to people who are not in the target audience and unlikely to purchase the advertiser's products or services. Internet advertising has a limited capability to provide metrics regarding impressions due to inefficient statistical tools, confusing standards or lack of adherence to existing standards, and online fraud. (A common form of online marketing fraud occurs when someone repeatedly clicks on an ad to artificially boost the referral fees that are paid to a site hosting the link. Often, the guilty party is the advertiser's competitor, who may employ a robot to automate this process, which ultimately causes the advertiser to lose money by being required to pay for these fraudulent click-throughs. Better tools are being created to detect and prevent these occurrences.)

Current Internet or traditional advertising sales paradigms are unable to fulfill either the requirements of mobile advertisers or mobile device users, and unable to deliver the potential and accuracy that is available via mobile marketing. While an advertiser can purchase ad space on search engine results pages, such of those of Google or other popular search engines, based on a particular user-input keyword, and while this may help identify a user's temporary and non-contextual interest in a word, this service provides no way to modify the message depending on actual user demographics, preferences or location information. It similarly does not address the particular requirements of a user while the user is mobile, nor is it able to consider the actions presented by the wireless device itself as it powers on, powers off, or powers down into “screensaver” mode, or moves into another location. Furthermore, such a system requires the user to enter a search phrase, something that is difficult on most wireless devices. For example, if this system were implemented as is on wireless devices, when a dweller of New York City sets a preference for the keyword “transportation,” the advertiser of a Checker Cab company might wind up with his ad promoting a cross-town rush-hour special appearing at two o'clock in the morning or when the user turns on the phone in the Las Vegas airport. For mobile marketing, the Internet or more traditional methods are inefficient and detrimental to the advertiser and potentially irritating to the user. Thus, conventional Internet advertising techniques applied directly to mobile communication systems are insufficient and fail to take advantage of the unique user experiences that arise from the ability to carry mobile devices in various environments or surroundings.

Traditional advertising such as TV, radio, newspaper or billboards are broadcast to a large audience, and precise user targeting is difficult.

### BRIEF SUMMARY OF AN EXEMPLARY EMBODIMENT OF THE INVENTION

The present invention addresses the aforementioned problems by providing a system and method that enable wireless advertisers to purchase media space on a group of mobile communication devices, where the advertiser is able to: (1) select the recipients of the ad based on the user preferences, demographics, location and/or device actions; (2) stipulate the events or parameters that will in effect “trigger” the advertisement to be presented, and; (3) actively influence the priority of the ad's placement when presented on the device according to the conditions previously defined by participating in the open-market competition of a online auction. The invention also provides metrics that permit advertisers to assess the effectiveness of the message, placement priority or selected parameter(s).

The advertiser initially stipulates the events or parameters that will cause the ad to be transmitted to a targeted group of recipients, then participates in a real-time online auction by placing a bid to secure the priority placement of the ad. During operation of a mobile device, parameter data and/or event data is generated and transmitted to an advertising system associated with the mobile communications network. The parameter data and/or event data, along with any priority assigned to particular advertisements in response to bids by advertisers, is used to select advertisements and the timing thereof. The system of the invention also tracks impressions and provides metrics associated with the display of the advertisements and the response of users to the advertisements.

The advertising techniques of the invention enable advertisements to be delivered and displayed without a significant risk of causing wireless device users to be overwhelmed by a proliferation of promotions that are neither interesting nor relevant to them. In addition, according to the invention, advertisers can derive the value and full advantage of a highly-targeted and truly “mobile” messaging campaign. Moreover, the advertising systems and methods of the invention permit carriers of the service to realize the full potential of this new mobile marketing medium. The marketing systems of the invention are useful for advertisers because the advertisers can purchase wireless media space in a manner that permits them to: (1) engage and take advantage of the medium's unique capabilities and “intelligence” about the user, user's location, and information regarding the device itself, (2) make the purchase in a fair market environment and timely fashion, (3) easily provide and modify the content, and (4) access metrics to gauge the performance of an ad or ad campaign.

These and other aspects of embodiments of the present invention will become more fully apparent from the following description and appended claims.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a schematic view depicting aspects of an exemplary operating environment for embodiments of the invention.

FIG. 2 is a block diagram that conceptually illustrates an embodiment of the invention by which non-intrusive content is selected and displayed on a ticker of a mobile device of a target user.

FIG. 3 is a flow diagram that illustrates a method for selecting and displaying content on the ticker of FIG. 2.

FIG. 4 is a flow diagram that illustrates a method for implementing an online system by which advertisers bid for the service of displaying advertisements on tickers of mobile devices according to an embodiment of the invention.

### DETAILED DESCRIPTION OF EMBODIMENTS OF THE INVENTION

The present invention is directed to systems and methods for permitting wireless marketers to purchase priority advertising space on wireless devices for the purpose of presenting non-intrusive content to a mobile audience. The advertiser initially stipulates the event(s) or parameter(s) that will cause the ad to be transmitted to a targeted group of recipients, then participates in a real-time online auction by placing a bid to secure the priority placement of the ad. The system of the invention tracks impressions and provides metrics.

The present invention permits advertisers to target non-intrusive advertising content to be displayed on the ticker of mobile devices of specific users based on real-time parameters or events associated with the mobile devices and/or the users. Marketing on mobile devices offers distinct advantages to businesses and device users that have not previously been available to online advertisers. For instance, the network operator and the user of the device together define and regulate the promotional content that is allowed to appear on the device. This control benefits advertisers, because they can consider user-defined interests and/or the current location of the device to strategically identify, target and pay to present their ads only to likely customers—people who actively expressed an interest in receiving content related to the advertiser's products or services, or whose behavior reveals such an interest.

For example, consider an example of a traveler who boards a plane in San Diego destined for Las Vegas. Because of the homing chip installed in her mobile phone (or other means of locating the phone such as triangulation based on towers), it “knows” when she arrives in the Las Vegas airport. Since the traveler previously expressed an interest in coffee, the device is now able to receive and present advertisements regarding airport restaurants and coffee shops. In addition, the network operator may allocate the appearance of a certain number of “airport-related” ads, such as duty-free shops and limousine services. The network operator transmits the relevant advertising messages and the device presents them. The traveler, who is thus able to receive information or promotions specific to her particular needs of the moment, the advertiser, and the carrier, all benefit from this type of advertising. And advertisers now have a way to reach specific users by bidding to own the real estate on target devices.

I. Tickers Operating on Mobile Devices

The invention can be implemented in any of a variety of wireless devices, including cellular telephones, personal digital assistants, laptop computers and any other mobile device having a display device and suitably equipped to establish communication with a network. Content can be transmitted to the communication device using any of a number of content transmission mechanisms or “bearers” including, but not limited to cellular networks, internet protocol (IP) networks such as the Internet, satellite and terrestrial radio broadcasts, the 802.11 family of wireless local area networks, and Bluetooth networks.

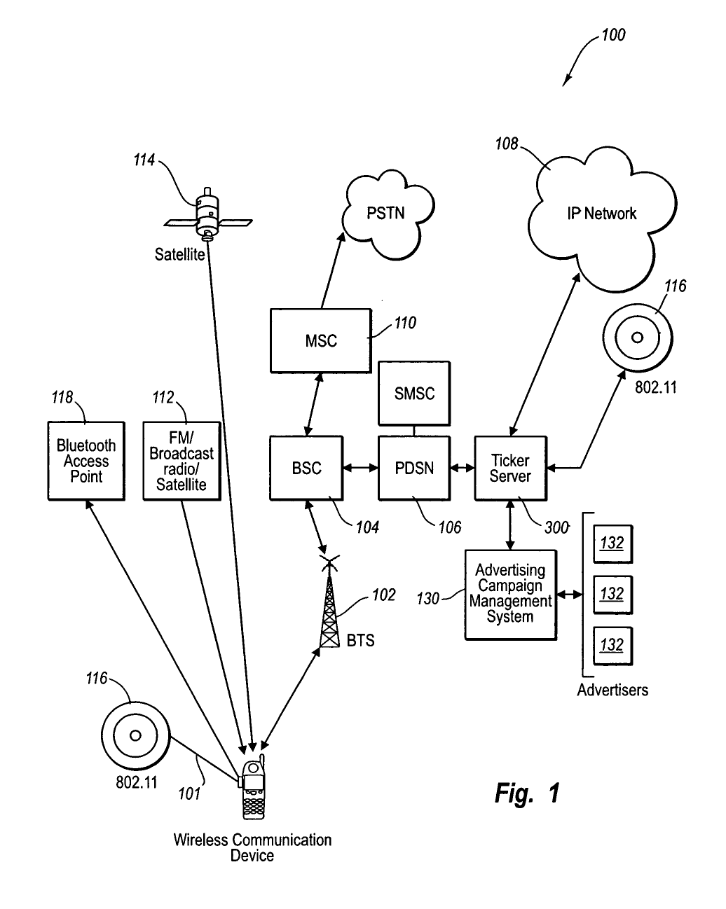

With particular attention now to FIG. 1, an exemplary embodiment of an operating environment 100 is shown. Although this exemplary operating environment comprises multiple types of networks, including a cellular telephone network, 802.11 networks, Bluetooth access points, and broadcast networks such as FM radio or satellite radio, the invention may be employed in connection with any other type of network and associated devices that are effective in implementing or facilitating wireless communication. While Accordingly, the scope of the invention should not be construed to be limited to the exemplary operating environment 100 of FIG. 1.

As shown in FIG. 1, the operating environment 100 includes one or more communication devices 102 configured to communicate with one or more networks and/or network elements, including base transceiver station (BTS) 104 of a cellular network, internet protocol (IP) network 106, FM, terrestrial, or satellite radio broadcast network 108, 802.11 networks 110, and Bluetooth access point 112. In addition, BTS 104 may be configured to use a base station controller (BSC) 114 to communicate with public switched telephone network (PSTN) 116 and packet data serving node (PDSN) 118. The BSC 114 is a component of a mobile network that contains all the logic used to control the operations of the BTS 104 and acts as an interface between the BTS 104, and the PSTN 116 and PDSN 118. PSTN 116 refers to regular land-line telephone systems, while PDSN 118 refers to the interface to a packet data network.

The geographical location of mobile communication device 102 can be determined using positioning systems and techniques such as a global positioning system (GPS) or wireless-assisted GPS, which uses one or more satellites 120. The location of communication device 102 may also be determined by other methods, such as by triangulation of the signal from the cell sites serving the communication device 102. The location of communication device 102 may also be determined when the communication device 102 encounters an 802.11 network access point or a Bluetooth access point. The location of the communication device 102 is effectively determined by referencing the access point that the communication device 102 encountered because in order to encounter the access point, the communication device 102 must be within a certain distance of the access point.

In addition to being configured to transmit and/or display content in the communication device based on geographical location, communication device 102 is further configured with ticker client software that, in one exemplary embodiment, enables the communication device 102 to render a ticker on the display screen of the communication device. Furthermore, the ticker client software enables the communication device 102 to communicate with ticker server 122, shown in one embodiment as a server operating in conjunction with IP network 106. Ticker server 122 may further interface with other network elements, such as a Short Message Service Center (SMSC) 124 and various gateways to implement the methods of the invention. Moreover, ticker client software is configured to allow the user of the communication device to save content received in the communication device and/or to forward content to other communication devices.

As well, some implementations of the ticker client software enable the user to forward received content to another user, or users with compatible devices and software, or to any email address. Additionally, embodiments of the ticker client software are configured, in some cases at least, to specify various third parties, in addition to the user, that are to receive the desired content. In still other cases, a user may specify that others receive the desired content, even though the user itself may not receive the content. Thus, a user could “bounce” content that was intended for the user, to another party.

The network 100 also includes an advertising campaign management system 130 (also referred to herein as “advertising system”) that is accessible to a plurality of advertisers 132. As described in greater detail hereinbelow, the advertisers 132 can initiate the implementation of non-intrusive advertising to be displayed on tickers in the network, including the ticker displayed on mobile device 102. As further described below, the advertising campaign management system includes servers that implement an on-line bidding system, servers that communicate with ticker server 122 to provide appropriate non-intrusive advertising content, and tracking systems to provide metrics of the effectiveness of the advertising initiated by advertisers 132.

Additional details regarding tickers that can be used with the invention are found in U.S. patent application Ser. No. 10/916,960, entitled “Systems and Methods for Populating a Ticker with Location Based Content,” filed Aug. 11, 2004, and U.S. patent application Ser. No. 11/061,422, entitled “Systems and Methods for Displaying Content in a Ticker, filed Feb. 18, 2005, which are incorporated herein by reference. Although the tickers described above and in the foregoing patent applications are suitable to be used with the invention, the advertising methods of the invention can also be implemented with other tickers and other display interfaces on mobile devices. While FIG. 1 illustrates a suitable operating environment in which the invention can be implemented, the advertising systems and methods of the invention can also be employed in a variety of other networks that can operate with a mobile device with a display device and the ability to communicate with the network.

II. Selection and Display of Advertising Content on Tickers

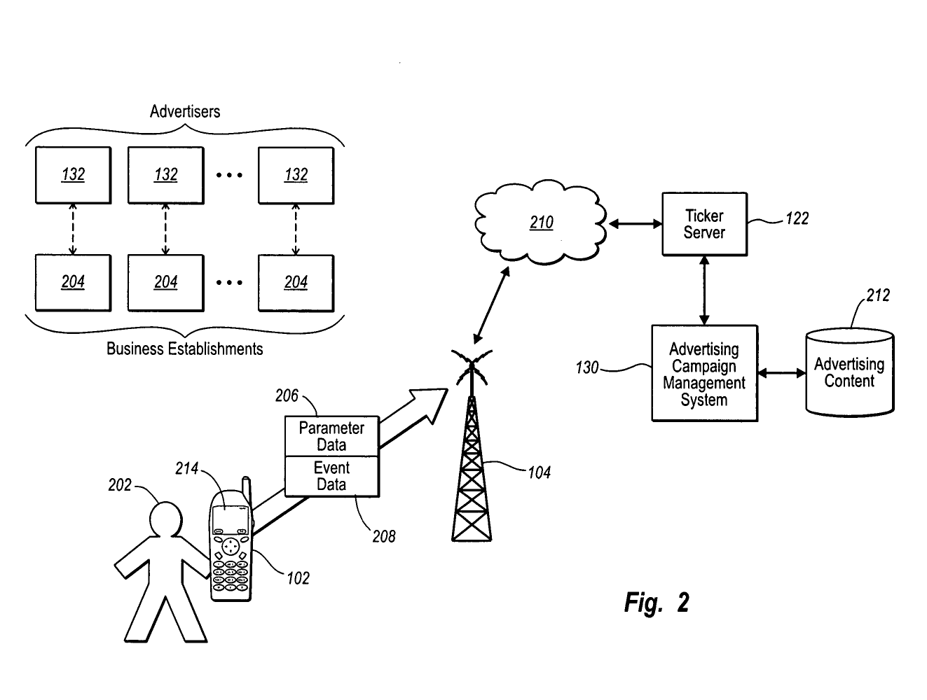

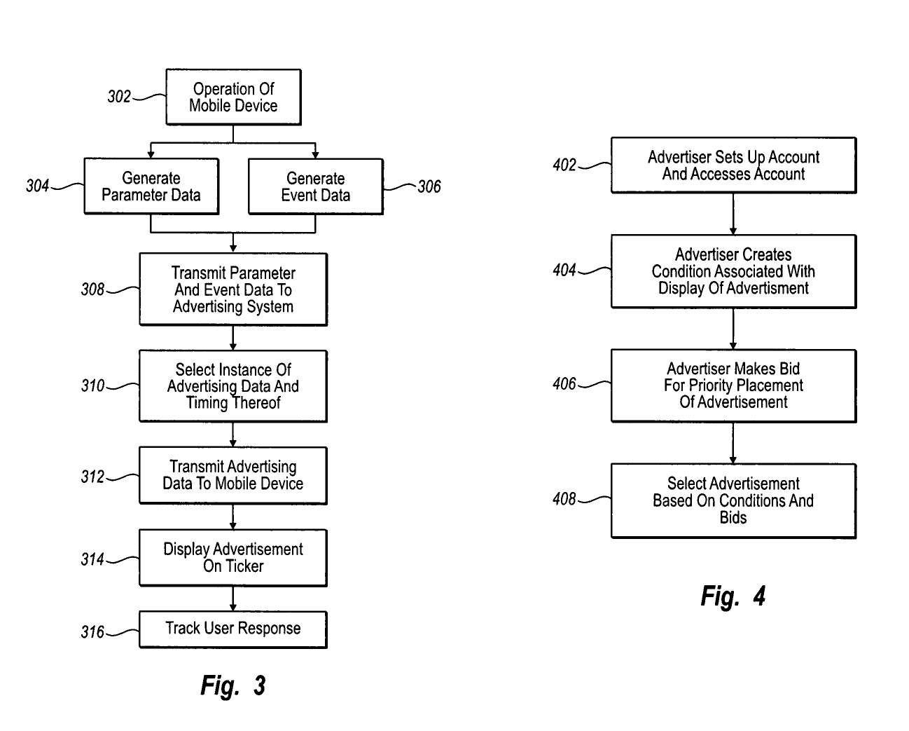

FIG. 2 is a block diagram that conceptually illustrates an embodiment of a method and system by which non-intrusive advertising content is selected and displayed on the ticker of a mobile device of a target user. FIG. 3 is a flow diagram that also illustrates an embodiment of this embodiment of the methods of the invention. As shown in FIG. 2, mobile device 102 is operated by a user 202 in a setting that includes business establishments and other sites 204 associated with advertisers 132 (step 302 of FIG. 3). During operation of the mobile device 102, parameter data 206 representing parameters that can be used to select content and instances of mobile advertisements is generated (step 304) based on activity of the mobile user 202, activity associated with the mobile device 102, or other input that provides information about the mobile user or the mobile device.

Examples of parameters that are used to select the content and instances of mobile advertisements include, but are not limited to, (1) target market demographics provided by the carrier or user; (2) user-defined preferences; (3) previous user behavior established vis-à-vis the device or purchases (for example, a user dials 411 to inquire about gardening shops, which establishes a user interest in gardening); (4) device location; (5) time of day in the current location of the device; (6) items the user has previously selected or purchased through the device; (7) ticker content channels the user is subscribed to; and (8) device configuration or other software on the device. In general, the term “parameter,” as used herein, extends to information that is used to identify or select non-intrusive content that is to be displayed on the ticker of a mobile device of a user.

During operation of the mobile device 102, event data 208 representing events that can be initiate the transmission or display of mobile advertisements is also generated (step 306) based on activity of the mobile user 202, activity associated with the mobile device 102, or other input that provides information about the mobile user or the mobile device.

Examples of events that trigger the display of mobile advertisements include, but are not limited to, (1) device actions (such as powering the device on or off, powering the device down into screen-saver mode, or flipping open the lid of the phone); (2) a specified series of phone or user actions (such as, the phone moving at a particular speed in a certain direction; the user turns off phone in one city and turns on the phone in another city; the user charges a purchase using the phone's “ATM” feature . . . ); (3) the receipt of an incoming message (IM, SMS, MMS, Voice, vNote) or a phone call by the device; (4) the receipt of an incoming message from the same sender over “x” number of times in a day/week; (5) the user signing up for a new mobile service; (6) the user downloading a new ring tone; (7) the user moving a mobile phone number over to a new device, or any other event associated with the mobile device that indicates that the device or user has engaged in a particular action, moved locations, or participated in some other activity. In general, the term “event” as used herein, extends to an action or state associated with a mobile device or a user thereof that is used to determine the timing or the initiation of the transmission and/or display of non-intrusive content on a ticker of a mobile device of a user. In some instances, the same action or state can act as a parameter and an event.

When the device performs a pre-defined action, or the prescribed circumstances otherwise prevail, the device is triggered to present content provided by the advertiser in the order of priority as governed by the bidding process and optionally other factors, such as frequency of display of a message, on to the display of the device. The parameter data 206 and the event data 208 in one embodiment is transmitted to a base transceiver station 104 and through network infrastructure 210 (e.g., the network components of FIG. 1) to ticker server 122 and advertising campaign management system 130 (step 308). At the advertising system 130, the data 206 and 208 is used to select an appropriate instance of advertising content 212 and the timing of the display of the advertising content on the ticker 214 of the mobile device 102 (step 310). The advertising system 310 initiates the transmission of the selected advertising content to the mobile device 102 (step 312). Based on the specified timing of the advertisement, the selected advertising data is then displayed (step 314) on the ticker 214 of mobile device 102.

In another embodiment, the parameter data 206 and event data 208 are used locally on mobile device 102 or at another network location between mobile device 102 and advertising system 130, where advertising content has previously been sent and cached. In any case, the parameter data 206 and event data 208 are used to select advertising content and to trigger the transmission or display of the advertising content, respectively.

The network operator can track the behavior or actions performed by the recipient of the advertisement (step 316) to provide a mechanism whereby purchasers of the media space can access and review these metrics. This user response data 212 is made available to the corresponding advertisers 132 at, for example, advertising system 130 or using another resource of the network.

III. Advertiser Bidding System

As illustrated in FIG. 4, the invention also extends to methods for operating and using an electronic or online bidding process to sell advertising impressions to advertisers 132. The bidding process of the invention is easily accessible, and helps ensure that the pricing structure reflects the current open-market value of access to an audience of self-identified (and prospective) customers.

According to this embodiment of the invention, a mobile advertiser sets up an account and password on a secure server, then accesses the account by going to a secure Web site and entering a password (step 402). Once on the site, the advertiser selects the parameter(s) or event(s) (e.g., those described above) that, together, create a condition intended to trigger the presentation of the ad on the group of devices as defined (step 404). For example, the advertiser provides parameter specification data that specifies at least one parameter associated with target mobile devices or target mobile users that is to be used to select a particular advertisement for display on a ticker of a selected mobile device. Similarly, the advertiser can provide event specification data that specifies at least one event associated with target mobile devices or target mobile users that is to be used to trigger the display of the particular advertisement on the ticker. The resulting “condition” is a single or set of circumstances that are being auctioned on the site.

The advertiser 132 then enters this particular auction and enters a bid of an amount that she is willing to pay in order to improve the likelihood that her ad will enjoy priority placement when it is “aired” (step 406). Each bid is specific to the set of parameter(s) or event(s), and openly reveals the current bid price to the rest of the site members. The parameters or events may be optionally weighted for importance by the advertiser. The higher the advertiser bids for preferred placement, the more advantageous the placement of the ad when it is finally conveyed and presented to the specified audience. The auctions are typically ongoing, and a prospective advertiser can initiate bidding at any time.

During operation of the advertising system 130, the parameter data 206 and event data 208 is used to determine whether it matches the condition defined by the advertiser. In addition, the decision made by the advertising system regarding the appropriate advertisement to be displayed on the ticker 214 of the mobile device 102 is also based on the priority given to particular advertisements resulting from the bids made by the corresponding advertisers. These criteria result in a particular advertisement being delivered and subsequently displayed on the ticker 214 of the mobile device 102 (step 408).

The content, including advertising, is managed by a third-party content aggregator associated with advertising system 130, such as a service that provides RSS feeds on the Internet. The aggregator typically determines the number of ads and the length of the ads that can be presented on the device when triggered by a certain condition or circumstance. Each bid is for a one or more-time presentation or one-or more time click through on a device, or for a predetermined period of time, or for a total number of clicks or presentations to meter overall ad spending, or for any combination of variables as set by the content aggregator. The advertiser provides advertising content via the secure Web site of the invention, by uploading it directly to the aggregator. Depending on the format of the ticker, content can be provided in a text, image or multi-media file. The advertiser can access her account on the secure Web site to change the content, modify parameters, view ad statistics for any previous presentation, retrieve archived content, and review current and prior payment status or bidding history.

While the foregoing bidding process can be a useful method for enabling advertisers to initiate the distribution of advertising content, it is possible that the fee structure itself may take various forms. For example, advertising messages that are acted-upon by the recipients (such as via a click-through common to Internet advertising) the service may exact a premium that is pre-defined by the network operator, carrier and/or content aggregator, and agreed to by the advertiser. Alternatively, the premium might be included in the auction bid. The advertiser's fee would then be based on the priority fee established in the bidding process, plus the number of direct user interactions that the ad generated as a result of the presentation. In all cases, the aggregator should provide a method whereby the advertiser can view click-through rates or other statistics. A term appropriated from banner advertising on the Internet, a “click-through” on a wireless device, occurs when the user interacts with an ad that appears on the ticker, causing either a request to be sent to the advertise or more information to be displayed locally, and the click-through logged by the usage accountant. The click-through can be instantiated as a click, a vocal command, a phone movement, or any other interaction intended to exact a response from the device.

Finally, as mentioned, it is possible that more than one parameter can be considered when determining the “condition” that will trigger the advertisement to be presented. For example, a vendor in the Las Vegas airport may be willing to pay a premium for his ad to appear on mobile devices whose users have expressed an interest in coffee, when those devices appear in a specific Las Vegas airport terminal between 5 AM and 10 PM. Presenting this ad on these same devices when they appear in the airport will have no value to the advertiser after 10 PM, when vendor's coffee shop closes for the evening. Therefore, in this example, the vendor would like to set three parameters to define the condition that will cause his ad to be presented, including:

Who: Users who set a preference for “coffee”

Where: A specific Las Vegas airport terminal

When: Between 5 AM and 10 PM.

The invention provides a mechanism for weighting these three parameters. This is necessary because another coffee vendor in the same terminal might be open 24 hours and so would not care about the “When” parameter. The advertiser specifies the “When” parameter, and the system optimizes when the ads are displayed based on the desires of the advertisers.

The ability to specify specific parameters and/or events that are to be present when an advertisement is displayed permits advertisers to carefully tailor advertising campaigns to users who have a reasonable likelihood of being interested in the advertisement. From the standpoint of the user, the advertisements displayed according to embodiments of the invention are generally non-intrusive and are displayed in a manner that does not require the user to respond in order to continue to operate the mobile device. Then the parameters or events that result in the selection and triggering of advertisements relate to the location of the mobile device, the advertisements often relate to the real-time surroundings of the mobile device, which can be beneficial to the user. Similarly, advertisements that are tailored to demographic information associated with the user and stated preferences of the user can also result in advertisements that are welcomed by the user.

IV. Telecommunication Devices and Computing Environments

Embodiments of the present invention may be implemented in connection with a special purpose or general purpose telecommunications device, including wireless telephones and other telephony-enabled mobile devices, personal digital assistants, laptop computers, or other mobile special purpose or general purpose computers that are adapted to have telecommunications or data networking capabilities. Embodiments within the scope of the present invention also include computer-readable media for carrying or having computer-executable instructions or electronic content structures stored thereon, and these terms are defined to extend to any such media or instructions that are used with telecommunications devices.

By way of example, and not limitation, such computer-readable media can comprise RAM, ROM, EEPROM, CD-ROM or other optical disk storage, magnetic disk storage or other magnetic storage devices, or any other medium which can be used to carry or store desired program code in the form of computer-executable instructions or electronic content structures and which can be accessed by a general purpose or special purpose computer, or other computing device.

When information is transferred or provided over a network or another communications connection (either hardwired, wireless, or a combination of hardwired or wireless) to a computer or computing device, the computer or computing device properly views the connection as a computer-readable medium. Thus, any such a connection is properly termed a computer-readable medium. Combinations of the above should also be included within the scope of computer-readable media. Computer-executable instructions comprise, for example, instructions and content which cause a general purpose computer, special purpose computer, special purpose processing device or computing device to perform certain function or group of functions.

Although not required, aspects of the invention have been described herein in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

What is claimed is:

1. In a mobile communication system in which a mobile device operated by a user includes a ticker capable of displaying information, a method of displaying non-intrusive advertising content on the ticker, comprising:
during operation of the mobile device, obtaining one or more of:
parameter data that represents at least one parameter associated with the mobile device or the user; and
event data that represents at least one event associated with the mobile device or the user; and
based on said one or more of the parameter data and the event data, selecting:
an advertisement from among a plurality of advertisements and obtaining advertising content associated with the selected advertisement; and
selecting a time for display of the selected advertisement on the ticker, such that the selected advertising content is displayed on the ticker at the selected time.

2. The method of claim 1, further comprising transmitting the selected advertising content from an advertising system of the mobile communication system to the mobile device such that the selected advertising content is displayed on the ticker at the selected time.

3. The method of claim 1, wherein selecting an advertisement is performed based on a priority assigned to certain advertisements, wherein the priority is assigned based on bids made by advertisers associated with said certain advertisements.

4. The method of claim 1, where selecting an advertisement for display is governed by advertiser spending limits.

5. The method of claim 1, where the number of user click-throughs is stored on the device and transmitted back to the server at a later time.

6. The method of claim 1, wherein the at least one parameter comprises one or more of:
a location of the mobile device;
a time of day of operation of the mobile device;
software currently residing on the mobile device;
the user's purchase history;
content that the user has subscribed to or purchased;
demographic information relating to a user of the mobile device; and
preferences expressed by the user of the mobile device.

7. The method of claim 1, wherein:
the parameter includes a location of the mobile device; and
the method further comprises determining the location of the mobile device, such that the advertisement displayed on the ticker of the mobile device is selected to correspond with the real-time surroundings of the mobile device.

8. The method of claim 1, further comprising receiving payment from the advertiser associated with the selected advertisement after display of the advertisement on the ticker based on information specifying that the user of the mobile device has performed a click-through of the displayed advertisement.

9. The method of claim 1, wherein selecting an advertisement is further performed based on conditions identified by the advertiser associated with the advertisement that define the parameters of the mobile device that are to be present when the advertisement is displayed on the ticker of the mobile device.

10. The method of claim 1, wherein the advertisement is displayed on the ticker in a manner that permits the user to continue to operate the mobile device without responding to the advertisement.

11. The method of claim 10, wherein the advertisement is passively displayed on the ticker.

12. The method of claim 1, wherein:
the parameter data is used to select the advertisement from among a plurality of advertisements; and
the event data is used to select the time for display of the selected advertisement on the ticker.

13. In a mobile communication system, a method of receiving and processing advertisement campaign information from an advertiser such that advertisements can be displayed on tickers of mobile devices operating in the mobile communication system, comprising:
receiving, from the advertiser, one or more of:
parameter specification data that specifies at least one parameter associated with target mobile devices or target mobile users that is to be used to select a particular advertisement for display on a ticker of a selected mobile device; and
event specification data that specifies at least one event associated with target mobile devices or target mobile users that is to be used to trigger the display of the particular advertisement on the ticker; and
storing said one or more of the parameter specification data and the event specification data for later use in selecting an advertisement and the time at which the selected advertisement is to be displayed on the ticker.

14. The method of claim 13, further comprising:
receiving from other advertisers, one or more of:
other parameter specification data from a plurality of other advertisers; and
other event specification data from the plurality of other advertisers; and
storing said one ore more of the other parameter specification data and the other event specification data, such that parameters and events associated with the mobile device can be used to select an advertisement and the time at which the selected advertisement is to be displayed on the ticker from among a plurality of advertisements of a plurality of advertisers.

15. The method of claim 13, further comprising receiving a bid from the advertiser that specifies a priority assigned to the particular advertisement, wherein the priority is used to determine a frequency by which the particular advertisement is to be selected over other advertisements.

16. The method of claim 15, further comprising receiving input from the advertiser that changes the priority of the particular advertisement in response to information provided to the advertiser regarding the display of the advertisement on the tickers of the mobile devices.

17. The method of claim 15, wherein the information provided to the advertiser relates to click-throughs of the particular advertisement by users of the mobile devices.

18. The method of claim 15, wherein the information provided by the advertiser limits the display of the advertisement based on a budget set by the advertiser.

19. The method of claim 15, wherein the information provided to the advertiser relates to instances of the display of the particular advertisement on tickers of the mobile devices.

20. The method of claim 13, wherein the parameter specification data specifies parameters that include one or more of:
a location of the mobile device;
a time of day of operation of the mobile device;
software currently residing on the mobile;
the user's purchase history;
content that the user has subscribed to or purchased;
demographic information relating to a user of the mobile device; and
preferences expressed by the user of the mobile device.

21. The method of claim 13, further comprising receiving input from the advertiser that changes one or more of the parameter specification data and the event specification data information provided to the advertiser regarding the display of the advertisement on the tickers of the mobile devices.
